(19) United States
(12) Patent Application Publication
(10) Pub. No.: US 2009/0019400 A1
(43) Pub. Date: Jan. 15, 2009

(54) MEDICAL IMAGE PROCESSING APPARATUS AND PROGRAM

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 12/166,200

(22) Filed: Jul. 1, 2008

(30) Foreign Application Priority Data
Jul. 2, 2007 (JP) 2007-174302

(51) Int. Cl. G06F 3/048

(52) U.S. Cl. 715/840

(57) ABSTRACT

A medical image processing apparatus using volume data includes display control means, processing control means and button placement means. The display control means displays an individual processing area and a common processing area. The individual processing area displays a first individual processing button group including a first command button to which a first command is assigned and a second individual processing button group including a second command button to which a second command is assigned. The common processing area displays a common processing button group including a common command button to which a common command is assigned. The processing control means executes the first command and then subsequently executes the common command, and executes the second command and then subsequently executes the common command. The button placement means places the first and second command buttons in the individual processing area or places common command buttons in the common processing area.

This application is based on and claims priority from Japanese Patent Application No. 2007-174302, filed on Jul. 2, 2007, the entire contents of which are hereby incorporated by reference.

### BACKGROUND

1. Technical Field

The present disclosure relates to a medical image processing apparatus and program using volume data.

2. Related Arts

In recent years, attention has been focused on an art of visualizing the inside of a three-dimensional object with the progression of the image processing technology using a computer. Particularly, medical diagnosis using a Computed Tomography (CT) apparatus or an Magnetic Resonance Imaging (MRI) apparatus capable of visualizing the inside of a living body for finding a lesion at an early stage has been widely conducted in a medical field.

A method called “volume rendering” is known as a method of obtaining a three-dimensional image of the inside of an object. In the volume rendering, virtual ray is applied to a three-dimensional volume space filled with voxel (minute volume element) space, whereby an image is projected onto a projection plane. As a kind of this operation, a raycast method is available. In the raycast method, voxel values are sampled at given intervals along the ray path and the voxel value is acquired from the voxel at each sampling point.

The voxel is an element unit of a three-dimensional region of an object and the voxel value is unique data representing the characteristic of the density value of the voxel. The whole object is represented by voxel data of a three-dimensional array of the voxel values. Usually, two-dimensional tomographic image data obtained by CT is stacked in a direction perpendicular to the tomographic plane and necessary interpolation is performed, whereby voxel data of a three-dimensional array are obtained.

In the raycast method, it is assumed that virtual reflected light for a virtual ray applied from a virtual eye to an object is produced in response to the opacity artificially set for the voxel value. To capture a virtual surface, the gradient of voxel data, namely, a normal vector is found and a shading coefficient for shading is calculated from the cosine of the angle between the virtual ray and the normal vector. The virtual reflected light is calculated by multiplying the strength of the virtual ray applied to the voxel by the opacity of the voxel and the shading coefficient.

FIG. 8 is a drawing to show an example of a visual programming environment in a volume rendering system. In the technique shown in the figure, numeric data of the simulation result and experimental data are feeded to an application consists of modularized function. Modularized functions are iconized components of a visualization pipeline. Not only the visualization function, but also a database and Graphical User Interface (GUI) creation environment is provided and a development environment to construct an application is provided as a visual programming environment. (see e.g., Non-Patent Reference: Kabushikikaisha KGT: “AVS/Express: Hanyou kashika software”, searched on May 22, 2007, Internet site URL: http://www.kgt.co.jp/feature/express/.)

On the other hand, in a medical image processing apparatus contain highly specialized processing in addition to volume rendering, such as region extraction processing of a tissue and lesion part enhancement processing. These image processing exceeds simple visualization and thus representation cannot be performed by a simple pipeline.

Furthermore, in the visual programming environment in the above-described volume rendering apparatus, the data flow between the individual elements of the image processing pipeline for generating display image data from original data is visualized, and a filter can be added to make the image processing effect different. However, for example, if the visual programming environment is adopted in a medical image processing apparatus for handling a medical image, the general user does not understand collection processing or parallel processing of executing a plurality of processes in order and therefore it is not easy for the user to set the processes. It is also difficult to visually design the abstract program concept of the collection processing, the parallel processing of executing a plurality of processes in order.

### SUMMARY

Exemplary embodiments of the invention provide a medical image processing apparatus and program that enable even a user having a little knowledge of programming and image processing in visual programming relating to a medical image to easily make settings for executing a series of commands containing the abstract program concept such as collection processing.

According to one or more aspects of the present invention, there is provided a medical image processing apparatus using volume data. The medical image processing apparatus comprises:

display control means for displaying an individual processing area and a common processing area, said individual processing area displaying a first individual processing button group including a first command button to which a first command is assigned and a second individual processing button group including a second command button to which a second command is assigned, said common processing area displaying a common processing button group including a common command button to which a common command is assigned;

processing control means for executing the first command and then subsequently executing the common command, and for executing the second command and then subsequently executing the common command; and

button placement means for placing at least one of the first, and second and common command buttons at least either in the individual processing area or, placing common command button in the common processing area,

wherein the first, second and common commands include an execution command of image processing using the volume data.

According to one or more aspects of the present invention, said processing control means executes the first command and then subsequently executes the common command and then subsequently executes the second command and then subsequently executes the common command.

According to one or more aspects of the present invention, said processing control means executes in parallel: first processing of executing the first command and then subsequently executing the common command; and second processing of executing the second command and then subsequently executing the common command.

According to one or more aspects of the present invention, said display control means displays at least one pallet, and each of the pallets displays one or more command buttons in a display area of the pallet, and at least one of the pallets displays the individual processing area and the common processing area in the display area of the pallet.

According to one or more aspects of the present invention, if an execution command for executing all commands of command buttons in any of the pallets is entered, said display control means executes the first command and then subsequently executes the common command, and executes the second command and then subsequently executes the common command, and additionally preceding and/or the following, executes a command assigned to the command button of the pallet neither contained in the individual processing area nor the common processing area.

According to one or more aspects of the present invention, said display control means displays two or more pallets, and one of the two or more pallets includes the individual processing area and the common processing area, and at least one of commands assigned to command buttons displayed in a display area of said one pallet is an execution command for executing all commands assigned to command buttons in any other one of the two or more pallets.

According to one or more aspects of the present invention, said display control means displays two or more pallets, and one of the two or more pallets includes the individual processing area and the common processing area, and at least one of commands assigned to command buttons displayed in a display area of the other pallet is an execution command for executing all commands assigned to command buttons in said one pallets.

According to one or more aspects of the present invention, said button placement means places said at least one of the first, second and common command buttons in any positions in a drag-and-drop manner.

According to one or more aspects of the present invention, if one of command buttons is selected, said processing control means executes a command assigned to said one command button.

According to one or more aspects of the present invention, a parameter as to the command is set through the command button.

According to the configuration, the parameter concerning the command can be set easily.

Other aspects and advantages of the invention will be apparent from the following description, the drawings and the claims.

### BRIEF DESCRIPTION OF THE DRAWINGS

In the accompanying drawings:

FIG. 1 is a schematic view illustrating a computed tomography (CT) apparatus for acquiring volume data handled in a medical image processing apparatus according to one embodiment of the present invention;

FIG. 2 is a view illustrating a visual programming environment using GUI in the medical image processing apparatus according to the embodiment of the present invention;

FIG. 3 is a drawing to describe the technical terms used in the present invention;

FIG. 4 is a drawing to describe the details of command buttons 18 placed in a pallet 12;

FIG. 5 is a drawing (#1) to describe collection processing (parallel execution of commands) in the medical image processing apparatus of the embodiment;

FIG. 6 is a drawing (#2) to describe collection processing (parallel execution of commands) in the medical image processing apparatus of the embodiment;

FIG. 7 is a view illustrating another execution screen example in the medical image processing apparatus according to the embodiment of the present invention; and

FIG. 8 is a view illustrating an example of a visual programming environment in a volume rendering apparatus.

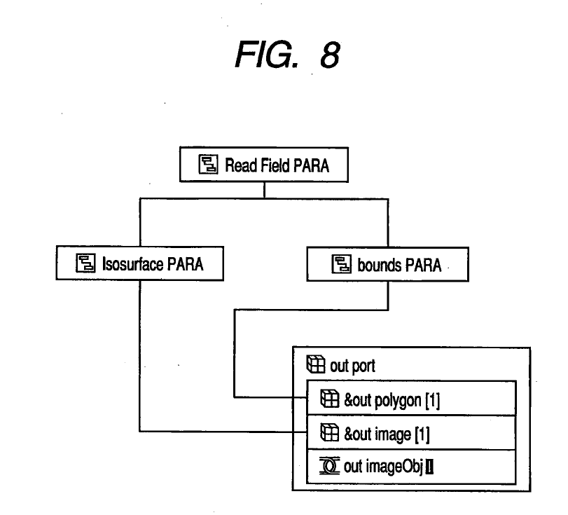

### DETAILED DESCRIPTION

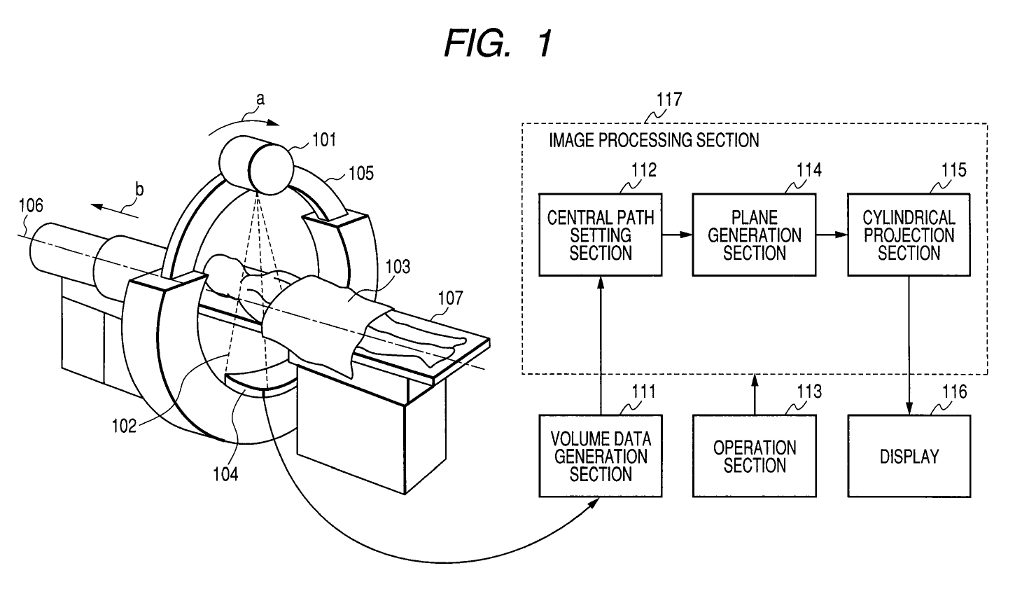

FIG. 1 is a schematic view illustrating a computed tomography (CT) apparatus for acquiring volume data handled in a medical image processing apparatus according to one embodiment of the present invention. The computed tomography apparatus visualizes the tissue of a specimen. An X-ray beam bundle 102 shaped like a pyramid (shown by the chain line in the figure) is radiated from an X-ray source 101. The X-ray beam bundle 102 passes through a specimen (a patient 103), for example, and is radiated to an X-ray detector 104. The X-ray source 101 and the X-ray detector 104 are arranged on a ring-like gantry 105 to face each other in the embodiment. The ring-like gantry 105 is supported on a retainer (not shown in the figure) so as to rotate (see arrow a) around a system axis 106 passing through the center point of the gantry.

The patient 103 lies down on a table 107 through which an X ray passes in the embodiment. The table is supported by a retainer (not shown) so as to move along the system axis 106 (see arrow b).

Therefore, the X-ray source 101 and the X-ray detector 104 can rotate around the system axis 106 and also can move relatively to the patient 103 along the system axis 106. Therefore, the patient 103 can be projected at various projection angles and at various positions relative to the system axis 106. An output signal of the X-ray detector 104 generated at the time is supplied to a volume data generation section 111, and then converts the signal into volume data.

In a sequence scanning, scanning is executed for each layer of the patient 103. Then, the X-ray source 101 and the X-ray detector 104 rotate around the patient 103 with the system axis 106 as the center, and the measurement system including the X-ray source 101 and the X-ray detector 104 photographs a large number of projections to scan two-dimensional tomograms of the patient 103. A tomographic image for displaying the scanned tomogram is reconstructed based on the acquired measurement values. The patient 103 is moved along the system axis 106 each time in scanning successive tomograms. This process is repeated until all tomograms of interest are captured.

On the other hand, in spiral scanning, the measurement system including the X-ray source 101 and the X-ray detector 104 rotates around the system axis 106 while the table 107 moves continuously in the direction of the arrow b. That is, the measurement system including the X-ray source 101 and the X-ray detector 104 moves continuously on the spiral orbit relatively to the patient 103 until all regions of interest of the patient 103 are captured. In the embodiment, the computed tomography apparatus shown in the figure supplies a large number of successive tomographic signals in the diagnosis range of the patient 103 to the volume data generation section 111.

Volume data generated by the volume data generation section 111 is introduced into a central path setting section 112 in an image processing section 117. The central path setting section 112 sets the central path of a tubular tissue contained in volume data. A plane generation section 114 determines a plane through which a virtual ray used for cylindrical projection passes from the setup central path and the volume data. The plane generated by the plane generation section 114 is supplied to a cylindrical projection section 115.

The cylindrical projection section 115 executes cylindrical projection on the volume data in accordance with the plane created by the plane generation section 114 thereby to generate a cylindrical projection image. The cylindrical projection image provided by the cylindrical projection section 115 is supplied to a display 116 and is displayed thereon. The display 116 produces composite display of a histogram, parallel display of images, animation display of displaying a plurality of images in sequence, simultaneous display with a virtual endoscope (VE) image in addition to display of the cylindrical projection image.

An operation section 113 contains a Graphical User Interface (GUI). The operation section 113 sets the central path, plane generation, and the display angle in spherical cylindrical projection in response to an operation signal from a keyboard, a mouse to generates a control signal of a setup value, and then supplies the control signal to the central path setting section 112, the plane generation section 114, and the cylindrical projection section 115. Accordingly, the user can change the image interactively while seeing the image displayed on the display 116 and can observe a lesion in detail.

The medical image processing apparatus according to the embodiment of the present invention is used in a visual programming environment to operate volume data acquired in the computed tomography apparatus. In the visual programming environment, a macro snippet is visualized using the GUI and particularly is provided with a collection processing (foreach) function. The macro mentioned here is a function of writing a specific operation procedure (command) of application software as a program for automation.

Generally, the collection processing is a processing sequence performed in batch for the elements in a container for storing the elements such as an array, a list, or a dictionary. The foreach statement is generally a statement for writing processing of repeatedly executing a predetermined predicate with each element in the container as an argument. In the Specification, the collection processing is processing of executing each element in the container and then executing predetermined processing repeatedly or concurrently. In the collection processing in the Specification, the types of processing (commands) corresponding to an argument and a predicate is not limited.

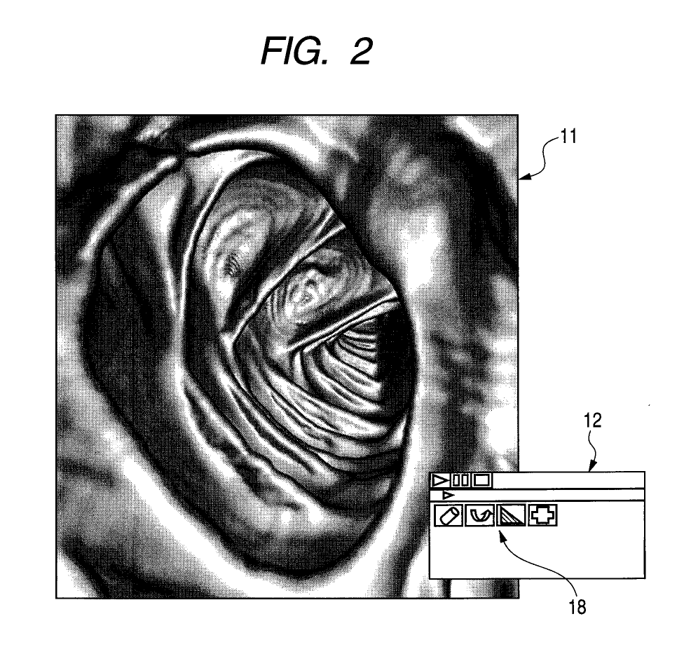

FIG. 2 is a view illustrating a visual programming environment using GUI in the medical image processing apparatus of the embodiment. In the medical image processing apparatus of the embodiment, for example, upon displaying a virtual endoscope image from volume data, a perspective projection image 11 of the inside of the colon is displayed on a display screen and a pallet 12 where a plurality of command buttons 18 are placed is also displayed. A command is assigned for each of the command buttons 18. Commands are command forming a macro. Commands are visualized image of operation such as image rotation processing and storage.

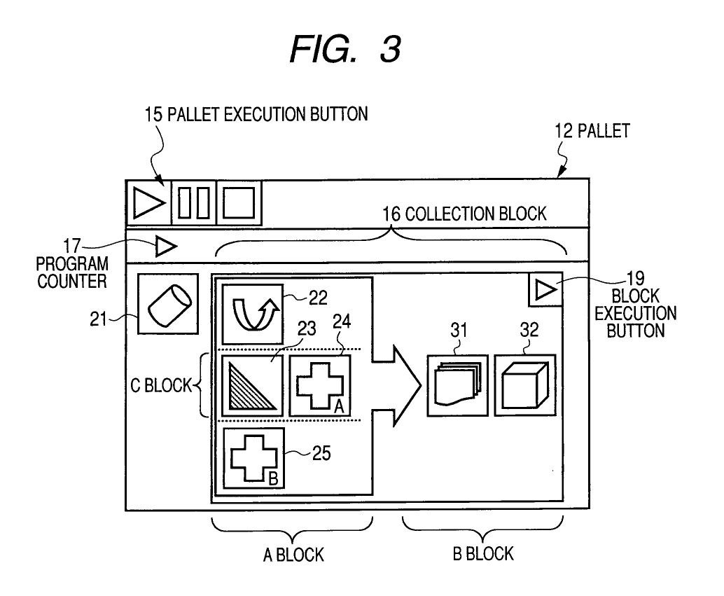

FIG. 3 is a drawing to describe the terms used in the Specification. FIG. 3 shows a display screen example of a display coupled to the medical image processing apparatus of the embodiment. The command buttons 18 are a button-like GUI to which predetermined commands are assigned, and show the predetermined commands of processing of generating a heart image viewed from a specific direction, for example. Usually, an image (icon, etc.,) for indicating the processing content is displayed on each of the command buttons. Moreover, a character or a character string may be displayed or a thumbnail image of the expected processing result may be adopted. The pallet 12 is a window as a placeholder of the command buttons 18 and displays the command buttons 18 in the display area.

A collection block 16 is an area for representing collection processing (foreach) and is divided into A, B and C blocks. The C block represents one or more command buttons 18 contained in each element in the container. The A block represents the container where the plurality of C blocks are placed. In the B block, the command button 18 is placed which corresponds to the predicate to be executed after executing the command button 18 in the C block. Namely, the C block corresponds to an individual processing button group where at least one command button 18 is placed. The A block corresponds to an individual processing area where at least two C blocks are displayed. The B block corresponds to a common processing button group where at least one command button 18 is placed. The A, B and C blocks are displayed on the display screen of the display connected to the medical image processing apparatus of the embodiment.

A block execution button 19 is a button for the user to enter an execution command of collection processing according to the command buttons 18 placed in the collection block 16 by clicking the block execution button 19 (pointing to the button by a pointing device). A pallet execution button 15 is a button for the user to enter an execution command of all of collection processing placed in the pallet 12 and the command button 18 not contained in the collection block 16 in order (all execution processing) by clicking the pallet execution button 15 (pointing to the button by a pointing device). The execution progress of the command buttons 18 placed in the pallet 12 is displayed on a program counter 17. The program counter 17 and the execution buttons 15 and 19 are omissible. A short cut key can be used in place of the execution button 15, 19. Neither the block execution button 19 nor the pallet execution button 15 is a kind of command button 18.

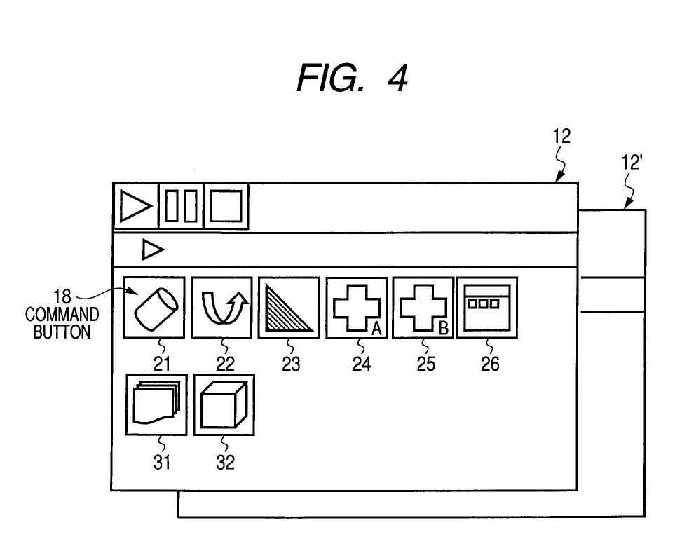

FIG. 4 is a drawing to describe the details of the command buttons 18 placed in the pallet 12 and the pallet 12′. The pallet is treated as an independent macro snippet (program) for each of pallets 12 and 12′. Command buttons 21 to 26, 31, and 32 treated as instructions (commands) contained in the macro and are visually discriminated from each other by symbols corresponding to the instructions. For example, a command of execution of raycast is assigned to a raycast button 21. If the user clicks the raycast button 21, a raycast method is selected from among various rendering methods for volume data, and then rendering according to the raycast method is performed.

A rotation button 22 is a button for rotating a selected image. A black and white inversion button 23 is a button for inverting the luminance or the hue of the selected image. A region extraction button 24 and a region extraction button 25 are buttons for extracting a region of interest from the volume data.

A command nest button 26 (command button as a command of calling a macro of different pallet) is associated with the different pallet 12′. The user clicks the command nest button 26, whereby all of a series of command buttons set in the different pallet 12′ can be executed in order and a similar effect to that of clicking the pallet execution button 15 of the different pallet is demonstrated. Accordingly, routine processing can be collected.

A folder button 31 enables the user to set the address of the storage location as a parameter, and for example, the data of the result of image processing can be stored in the setup address. A print button 32 is a button for outputting a rendering result image to an imager unit to perform print processing.

Thus, the commands are assigned to the corresponding command buttons 18 and detailed parameters can be set for each of the commands. For example, a rotation amount parameter can be set in a rotation command. A color parameter at the rending time can be set in a rendering command. A magnifying scale power parameter can be set in an enlarging command. Different parameters can also be assigned to the same kind of commands, and for example, a heart extraction parameter can be assigned to the region extraction button 24 and a liver extraction parameter can be assigned to the region extraction button 25.

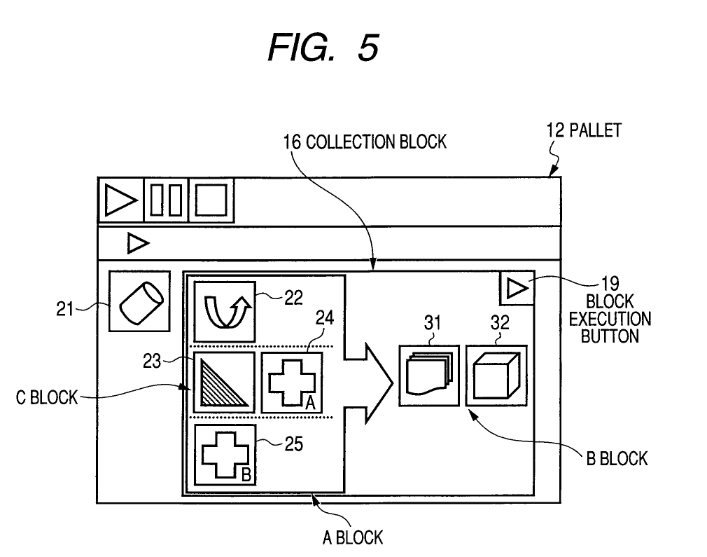

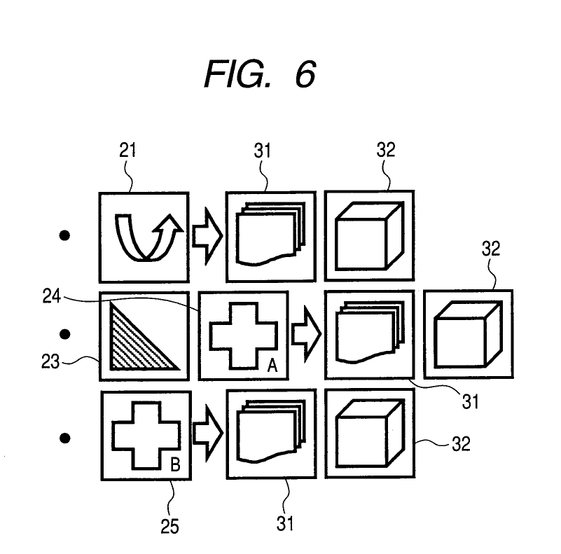

FIGS. 5 and 6 are drawings to describe the collection processing in the medical image processing apparatus of the embodiment. In the pallet 12, one collective block for conducting routine processing (collection block 16) can be created.

In FIG. 5, the raycast button 21 is placed in the pallet 12, the A block and the B block are set in the collection block 16, and three C blocks are set in the A block. That is, the folder button 31 and the print button 32 are placed in the B block, the rotation button 22 is placed in the first C block, the black and white inversion button 23 and the heart extraction button 24 are placed in the second C block, and the liver region extraction button 25 is placed in the third C block.

The command buttons 21 to 25, 31, and 32 are thus placed and if the user clicks the block execution button 19, the collection block 16 is interpreted as in FIG. 6 thus to be executed.

That is, the following (1) to (3) processings are executed.

(1) rotation (the rotation button 22), storage (the folder button 31), and print (the print button 32) processing for the selected image (processing of the B block following the first C block);

(2) black and white inversion (the black and white inversion button 23), heart extraction (the heart extraction button 24), storage (the folder button 31), and print (the print button 32) processing for the selected image (processing of the B block following the second C block); and

(3) liver extraction (a liver extraction button 25), storage (the folder button 31), and print (print button 32) processing for the selected image (processing of the B block following the third C block).

The cluster of the (1), (2), and (3) processing may be executed in sequence, or (1), (2), and (3) may be executed in parallel in separate threads (or separate processes or separate image processing apparatus). That is, the execution order needs to be guaranteed only in the combination of the individual C block and the B block. This is because independent processing is contained in each of the C blocks.

Thus, in the medical image processing apparatus of the embodiment, the command buttons 21 to 25, 31, and 32 are placed in the predetermined blocks, whereby the foreach processing can be implemented with GUI and the collection processing of grouping and executing routine processing can be easily represented. For example, processing of “storing” the rendering result after “rotating”; “storing” the rendering result after “enlarging”; and “storing” the rendering result after executing “affected part enhancement” can be easily represented. Thus, each row (C block and B block) of the collection block 16 can be executed independently and therefore can be executed in parallel.

Therefore, according to the medical image processing apparatus of the embodiment, any desired buttons are only arranged as GUI, whereby even the general user who does not understand the collection processing can flexibly set and even the general user who does not understand the parallel processing can benefit from the parallel processing.

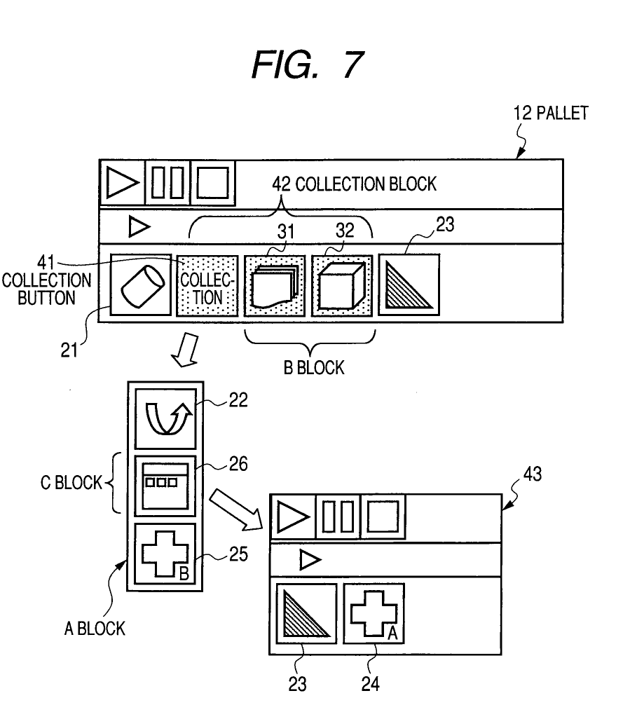

FIG. 7 shows another execution screen example in the medical image processing apparatus of the embodiment. In the medical image processing apparatus of the embodiment, the raycast button 21 and the black and white inversion button 23 are placed in the pallet 12 and a collection button 41 is placed in a collection block 42 and the B block is also set therein. The folder button 31 and the print button 32 are placed in the B block.

The collection button 41 enables the user to set the whole collection block 42. Namely, the user can set the range of the B block through the collection button 41. If the user operates the collection button 41 to edit the collection button 41, the rotation button 22, the command nest button 26, and the liver extraction button 25 representing the A block are displayed. That is, the A block of the embodiment is usually hidden and is displayed when the collection button 41 is edited.

In the C block, only one command button can be placed for simplicity. Even in this case, the command button in the C block includes another pallet, whereby an equal function to that of placing a plurality of command buttons can be provided. In the example in FIG. 7, the command nest button 26 in the C block includes a pallet 43 where the black and white inversion button 23 and the heart extraction button 24 are placed. Accordingly, the display area on the screen can be saved. Since the medical image processing apparatus requires a wide on-screen display area to display a medical image, it is preferable that the pattern provided for operation should be compact.

In the medical image processing apparatus of the embodiment, a command issued by a command button can be adapted according to target image (polymorphism) or the command can be skipped. For example, in selecting according to the image type and in issuing a command for a plurality of pallets, appropriate processing can be executed in response to the target image. Accordingly, if a command button of a color setting command according to a Look Up Table (LUT) function used in the raycast method is placed on a pallet, when the user clicks the pallet execution button with the target image as a Maximum Intensity Projection (MIP) image, execution of a color setting command unnecessary for the MIP image shall be skipped. Accordingly, a macro contained in a pallet having a collection block including complicated processing is applicable to an image which is not the essential object, and thus this point can contribute to easy operation of the user.

Negotiation as to whether or not parallel processing is available can be conducted. For example, parallel processing of a rotation command and a coloring command can be set “nonexclusive”, and parallel processing of a right rotation command and an upper rotation command can be set “exclusive”. That is, the commands that can be executed in parallel are automatically parallelized from among a series of commands concatenated from one C block to the B block, whereby the efficiency of the parallel processing can be further improved. Advanced exclusive control involved in the parallel processing can be automatically performed as it is hidden from the user.

One command can also be provided with a nested function call of a command contained in another pallet. The command buttons 18 enable the user to edit macro snipplet in a drag-and-drop manner.

In the pallet 12 of the embodiment, parameter edit for each button can be executed and the collection block 16 and 42 enables the user to select parallel execution or sequential execution. Further, a command button 18 including a plurality of commands for enlarging while rotating may be available.

As described above, according to the medical image processing apparatus, the medical image processing method, and the medical image processing program according to the embodiment, the command buttons 18 are placed in the collection block 16 and 42, whereby collection processing is set. Also, the command buttons 18 are placed in the C block and the B block, whereby parallel processing is set. Therefore, in medical visual programming, even the general user who does not understand the collection processing or the parallel processing can flexibly set collection processing and can benefit from the parallel processing.

If the user enters an execution command of all of the command buttons 18, the command buttons 18 placed in the pallet 12 are executed and subsequently the command buttons 18 placed in the collection block 16 and 42 are executed. Therefore, upon processing a large amount of medical routine image processing, the burden of the user can be significantly reduced. For example, complicated processing of extracting the heart from volume data can be performed efficiently.

According to the present invention, if any desired command button combination is placed in the individual processing area and the common processing area through GUI, a plurality of processes corresponding to the placed command button can be executed. Therefore, in medical visual programming, even the user having a little knowledge of programming can easily make settings for executing a series of commands containing the abstract program concept such as collection processing. Particularly, with regard to all individual processing button groups, the command assigned to the command button placed in the common processing button group is executed after execution of a command involved in each individual processing button group. Therefore, it is effective when the user wants to perform the same processing after different processing.

According to the present invention, the command buttons are placed in any desired order in the individual processing area or the common processing area, whereby the commands can be executed in any desired order. Therefore, even the user having a little knowledge of programming and image processing can easily make settings for executing a plurality of processes.

According to the present invention, processing of the command involved in the first individual processing button group and the command involved in the common processing button group following the command and processing of the command involved in the second individual processing button group and the command involved in the common processing button group following the command can be performed in parallel. Therefore, even the user having a little knowledge of programming can benefit from the parallel processing.

According to the present invention, the medical image processing apparatus has a command nest button for entering an execution command of all commands assigned to command buttons displayed in the first pallet. Therefore, upon repeating medical routine image processing, the burden of the user can be significantly lightened.

According to the present invention, the command buttons are sorted in a drag-and-drop manner of the user and the processing order is determined according to the sort order of the command buttons. Therefore, even the user having a little knowledge of programming and image processing in the medical field can extremely easily make settings for executing a plurality of processes.

According to the present invention, the user selects a command button, whereby various commands can be executed. Therefore, the burden of the user for processing a medical image can be reduced.

The present invention is applicable to a medical image processing apparatus and program using volume data.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A medical image processing apparatus using volume data, comprising:
display control means for displaying an individual processing area and a common processing area, said individual processing area displaying a first individual processing button group including a first command button to which a first command is assigned and a second individual processing button group including a second command button to which a second command is assigned, said common processing area displaying a common processing button group including a common command button to which a common command is assigned;
processing control means for executing the first command and then subsequently executing the common command, and for executing the second command and then subsequently executing the common command; and
button placement means for placing at least one of the first and second command buttons in the individual processing area or, placing common command button in the common processing area,
wherein the first, second and common commands include an execution command of image processing using the volume data.

2. The medical image processing apparatus as claimed in claim 1,
wherein said processing control means executes the first command and then subsequently executes the common command and then subsequently executes the second command and then subsequently executes the common command.

3. The medical image processing apparatus as claimed in claim 1, wherein said processing control means executes in parallel:
first processing of executing the first command and then subsequently executing the common command; and
second processing of executing the second command and then subsequently executing the common command.

4. The medical image processing apparatus as claimed in claim 1,
wherein said display control means displays at least one pallet, and
wherein each of the pallets displays one or more command buttons in a display area of the pallet, and
wherein at least one of the pallets displays the individual processing area and the common processing area in the display area of the pallet.

5. The medical image processing apparatus as claimed in claim 4, wherein
if an execution command for executing all commands of command buttons in any of the pallets is entered, said display control means executes the first command and then subsequently executes the common command, and executes the second command and then subsequently executes the common command, and
additionally preceding and/or the following, executes a command assigned to the command button of the pallet neither contained in the individual processing area nor the common processing area.

6. The medical image processing apparatus as claimed in claim 4,
wherein said display control means displays two or more pallets,
wherein one of the two or more pallets includes the individual processing area and the common processing area, and
wherein at least one of commands assigned to command buttons displayed in a display area of said one pallet is an execution command for executing all commands assigned to command buttons in any other one of the two or more pallets.

7. The medical image processing apparatus as claimed in claim 4,
wherein said display control means displays two or more pallets,
wherein one of the two or more pallets includes the individual processing area and the common processing area, and
wherein at least one of commands assigned to command buttons displayed in a display area of the other pallet is an execution command for executing all commands assigned to command buttons in said one pallets.

8. The medical image processing apparatus as claimed in claim 1, wherein said button placement means places said at least one of the first, second and common command buttons in any positions in a drag-and-drop manner.

9. The medical image processing apparatus as claimed in claim 1, wherein
if one of command buttons is selected, said processing control means executes a command assigned to said one command button.

10. The medical image processing apparatus as claimed in claim 1, wherein
a parameter as to the command is set through the command button.
